(19) United States
(12) Patent Application Publication
(10) Pub. No.: US 2019/0050893 A1
(43) Pub. Date: Feb. 14, 2019

(54) Linking Offline Location Signals to Online Conversions

(71) Applicant: Google Inc., Mountain View, CA (US)

(72) Inventors: Matthew Nicholas Stuttle, Lewes (GB); Chandrasekhar Thota, Saratoga, CA (US)

(73) Assignee: Google Inc., Mountain View, CA (US)

(21) Appl. No.: 14/181,167

(22) Filed: Feb. 14, 2014

(51) Int. Cl. G06Q 30/02

(52) U.S. Cl. CPC G06Q 30/0246; G06Q 30/0261

(57) ABSTRACT

The user enters a merchant location with a user device. An account management system logs an action of the user device at the merchant location. The account management system transmits a location-based offer to the user device. The user device receives the location-based offer and the user selects the location-based offer on the user device. The user desires to make a purchase from the merchant system and accesses the merchant website. The user initiates a transaction with the merchant via the merchant website. The account management system logs the user purchase activity and notes a conversion. For example, a conversion occurs when a user receives a location-based offer and then later purchases online a product or service from a merchant or manufacturer associated with the offer. The merchant system processes the transaction and the account management system logs the conversion of the offer.

### TECHNICAL FIELD

The present disclosure relates generally to offer conversions, and more particularly to linking offline location signals to online purchases.

### BACKGROUND

Advertisers would like to link online user activity with offline user activity, such as when a user views an online ad and then subsequently visits a merchant's physical location. However, conventional technology does not allow linking offline user activity with online user activity. This information could be valuable to understanding how “showrooming,” offering in-store coupons and offers, and other forms of advertising in a merchant's physical location affect a user's subsequent online behavior. This information would be useful in developing more effective offline marketing to influence online behavior of users.

### SUMMARY

In certain example aspects described herein, a computer-implemented method to link user initiated geo-location signals and user receipt of location-based offers to online conversions is provided. In an example embodiment, the user enters a merchant location with a user device. An account management system logs an action of the user device at the merchant location. For example, the user signs in to the merchant's Wi-Fi network, the user purchases a product using the user computing device digital wallet that is associated with the account management system, or signs in to an application via the user device and agrees to submit a current location to the account management system. The account management system transmits a location-based offer to the user computing device. The user computing device receives the location-based offer and selects the location-based offer on the user device.

The user desires to make a purchase from the merchant system and accesses the merchant website. The user initiates a transaction with the merchant via the merchant website. The account management system logs the user purchase activity and notes a conversion. For example, a conversion occurs when a user receives a location-based offer and then later purchases online a product or service from a merchant or manufacturer associated with the offer. The merchant system processes the transaction and the account management system logs the conversion of the offer.

In certain other example aspects described herein, a system and a computer program product to correlate online user purchase activity with prior receipt of a location-based offer are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for linking user initiated geo-location signals and user receipt of location-based offers to online conversions, in accordance with certain example embodiments.

FIG. 2 is a block flow diagram depicting a method for correlating online user purchase activity with prior receipt of a location-based offer, in accordance with certain example embodiments.

FIG. 3 is a block flow diagram depicting a method for transmitting a location-based offer to a user device, in accordance with certain example embodiments.

FIG. 4 is a block diagram depicting a computer machine and module, in accordance with certain example embodiments.

### DETAILED DESCRIPTION OF EXAMPLE EMBODIMENTS

### Overview

The example embodiments described herein provide computer-implemented techniques for linking user initiated geo-location signals and user receipt of location-based offers to online conversions. In an example embodiment, the user enters a merchant location with a user device and performs an action with the user device that enables the account management system to log the user location. The account management system may transmit a location-based offer to the user device. Later, when the user makes an online purchase, the account management system logs the user purchase activity and notes a conversion. The account management system may serve another advertisement to the user if a conversion is not noted at the time that the user is at the particular location.

The user enters a merchant location with a user device. In an example embodiment, the user brings a user device to the merchant's physical location (for example, a store, supermarket, or warehouse). In an example embodiment, the user device is a mobile phone or other mobile user device that can connect to a network.

The account management system logs an action of a user device at the merchant location. In an example embodiment, the user has authorized a location-based alert application. In another example embodiment, the user signs in to a merchant's Wi-Fi network. In another example embodiment, the user purchases a product at the merchant location using a user device digital wallet that is associated with the account management system. For example, a “product” may be any tangible or intangible product, as well as a service. In yet another example embodiment, the user signs in to an application via the user device and agrees to submit a current location to the account management system. For example, the user signs in to a mapping application administered by the account management system to get directions to the merchant location. In this same example, the user agrees to submit location data for the account management system to provide the mapping service. In this same example, the account management system logs the user's location when he arrives at the merchant location.

The account management system transmits a location-based offer to the user device. In an example embodiment, a location-based offer is an advertisement or a coupon that is transmitted when the user device is in a certain physical location. In an example embodiment, the account management system transmits a location-based offer on behalf of the merchant associated with the merchant location. For example, the account management system agrees to provide location-based offers for the merchant to users having an account with the account management system. In another example embodiment, the account management system transmits a location-based offer on behalf of a manufacturer of a product or service that is the subject of the advertisement.

The user device receives the location-based offer. In an example embodiment, the user receives the location-based offer on the user device via email, text message, an application resident on the user device, the merchant website or other website active on the user device web browser, or by any other method wherein the user may receive the location-based offer on the user device. The user selects or otherwise interacts the location-based offer via the user interface of the user device. In an example embodiment, the user actuates a user interface object to select the offer. In another example embodiment, rather than the user selecting the location-based offer, the location-based offer captures the user's attention. For example, the location-based offer is designed to expand to occupy the user interface of the user device or to provide a pop-up, banner, or other notification via the user interface. In certain embodiments, the user does not receive a location-based offer.

The user desires to make a purchase from the merchant system. In an example embodiment, the user left the merchant's physical location before making the purchase. In another example embodiment, the user is at the merchant's physical location but desires to purchase the product advertised online. In another example embodiment, the user desires to make a purchase from a manufacturer. For example, the location-based offer advertised a product that the merchant supplies but the user desires to purchase the product directly from the manufacturer.

The user accesses the merchant website. In an example embodiment the user accesses the merchant website with the same user device from which the account management system logged location data. In another example embodiment, the user accesses the merchant website using another user device. In an example embodiment, the user opens a web browser or application on the user device to access the merchant website. In another example embodiment, the user actuates a user interface object to select the location-based offer, which redirects the user device web browser (or application) to the merchant website. In another example embodiment, the user accesses the website of a manufacturer.

The user initiates a transaction with the merchant via the merchant website. In an example embodiment, the user selects a form of payment administered by the account management system as the form of payment. For example, the user selects a proxy card administered by the account management system or digital wallet account associated with the account management system comprising financial account information as the form of payment. In another example embodiment, the user uses the location-based offer comprising a coupon in the transaction.

The account management system logs the user purchase activity and notes a conversion. For example, a conversion occurs when a user receives a location-based offer and then later purchases online a product or service from a merchant or manufacturer associated with the offer or by purchasing a product or service associated with the offer. In another example, the user did not receive a location-based offer, but the user computing device was logged as having been at the location of the merchant system. In this instance, the user may have been exposed to in-store advertising, physical offers, spoken sales information, or other advertisement methods. In an example embodiment, the user device can communicate location information from the user device to the account management system for the account management system to obtain information regarding user's location. In another example embodiment, the account management system is notified of the user's purchase activity because the method of payment selected by the user is managed by the account management system. For example, the user pays with a digital wallet or proxy card associated with the account management system. In another example embodiment, the account management system places a cookie on the user device web browser when the user selects the location-based offer on the user device. In this same example embodiment, the account management system recognizes the cookie on the user device web browser when the user initiates the transaction. In another example, the account management system is notified of the conversion by the merchant system or the website on which the user conducted the transaction.

The merchant system processes the transaction. For example, the merchant system credits the merchant's financial account and debits the user's financial account. In another example embodiment, a manufacturer processes the transaction.

The account management system logs the conversion. The conversion may be logged by the account management system to use for statistical purposes, to serve future offers, or for any suitable purpose. The conversion may be transmitted to the merchant system, a manufacturer, or other party by the account management system. The conversion may be billed to a merchant system, a manufacturer, or other party. The account management system may use the conversion for any suitable purpose.

### Example System Architecture

Turning now to the drawings, in which like numerals indicate like (but not necessarily identical) elements throughout the figures, example embodiments are described in detail.

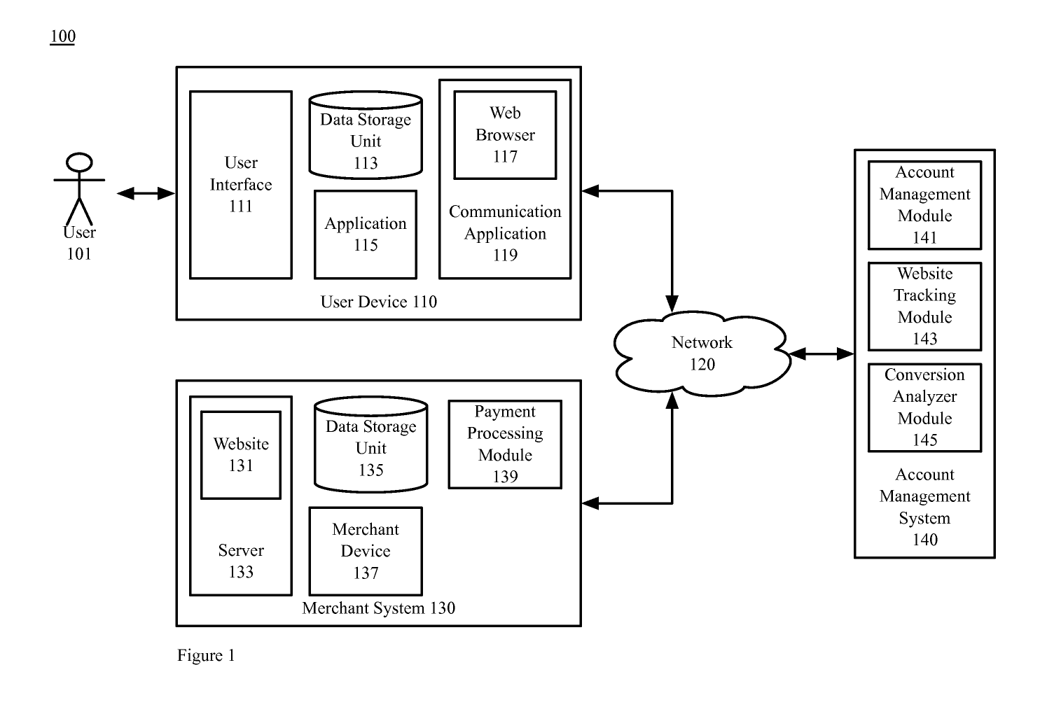

FIG. 1 is a block diagram depicting a system 100 for linking user initiated geo-location signals and user receipt of location-based offers to online conversions, in accordance with certain example embodiments. As depicted in FIG. 1, the system 100 includes network computing devices 110, 130, and 140 that are configured to communicate with one another via one or more networks 120. In some embodiments, a user associated with a device must install an application and/or make a feature selection to obtain the benefits of the techniques described herein.

For example, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 130, and 140 includes a device having a communication module capable of transmitting and receiving data over the network 120. For example, each network computing device 110, 130, and 140 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 130, and 140 are operated by users 101, merchant system operators, and account management system operators, respectively.

An example user computing device 110 comprises a user interface 111, a data storage unit 113, an application 115, a web browser 117, and a communication application 119. In an example embodiment, the user interface 111 enables the user 101 to interact with the application 115 and/or the web browser 117. For example, the user interface 111 may be a touch screen, a voice-based interface or any other interface that allows the user 101 to provide input and receive output from an application or module on the user computing device 110. In an example embodiment, the user 101 selects a location-based offer on an application 115 or web browser 117 by actuating a user interface 111 object.

In an example embodiment, the data storage unit 113 comprises a local or remote data storage structure accessible to the user computing device 110 suitable for storing information. In an example embodiment, the data storage unit 113 stores encrypted information, such as HTML5 local storage.

In an example embodiment, the user 101 can use a communication application 119, such as a web browser 117 application or a stand-alone application 115, to view, download, upload, or otherwise access documents or web pages via a distributed network 120.

In an example embodiment, the application 115 is a program, function, routine, applet, or similar entity that exists on and performs its operations on the user computing device 110. In certain embodiments, the user 101 must install the application 115 and/or make a feature selection on the user computing device 110 to obtain the benefits of the techniques described herein. In an example embodiment, the user 101 may access the application 115 on the user computing device 110 via a user interface 111. In an example embodiment, a user 101 signs in to the application 115, which enables the account management system 140 to log the user device 110 location data. In an example embodiment, the application 115 receives a location-based offer from the account management system 140 via the network 120. In another example embodiment, the application 115 enables the user 101 to access the merchant system 130 website 131 to purchase a product.

In an example embodiment, the communication application 119 can interact with web servers or other computing devices connected to the network 120, including the user computing device 110 and the web server 133 of the merchant system 130.

In an example embodiment, the web browser 117 can enable the user 101 to interact with web pages using the user computing device 110. In an example embodiment, the user 101 accesses the web browser 117 to sign in to an online application to enable the account management system 140 to log the user device 110 location data. In an example embodiment, the user 101 receives a location-based offer from the account management system 140 via the web browser 117. In another example embodiment, the account management system 140 transmits a cookie to the web browser 117 in response to a user 101 accessing a website or selecting a location-based offer to use to log allowed online activity by the user 101. In an example embodiment, the user 101 accesses the merchant system website 131 using the web browser 117. The user 101 has allowed the website 131 to allow a cookie to be transmitted.

An example merchant system 130 comprises a website 131, a server 133, a data storage unit 135, a merchant device 137, and a payment processing module 139.

In an example embodiment, the website 131 communicates with the user device 110 application 115. In another example embodiment the website 131 communicates with the web browser 117 via the communication application 119. In an example embodiment, the website 131 communicates with the account management system 140. In an example embodiment, the user 101 receives a location-based offer from the account management system 140 via the website 131. In this same example embodiment the user 101 selects the location-based offer on the website 131 via the web browser 117 and user interface 111.

In an example embodiment, the web server 133 provides the content that the user 101 accesses through the application 115 and/or the web browser 117 on the user computing device 110, including but not limited to html documents, images, style sheets, and scripts. In an example embodiment, the web server 133 supports the merchant system's 130 web site 137, which enables the user 101 to select an item for purchase.

In an example embodiment, the data storage unit 135 comprises a local or remote data storage structure accessible to the merchant system 130 suitable for storing information. In an example embodiment, the data storage unit 135 stores encrypted information, such as HTML5 local storage.

In an example embodiment, the merchant device 137 is a network 120 device at a merchant system's 130 physical location, for example, a Wi-Fi network device. In an example embodiment, the merchant device 137 receives a probing request from the user device 110 as the user device 110 requests to establish a network 120 connection. In this same example embodiment, this action by the user device 110 enables the account management system 130 to log the user device 110 location data.

In an example embodiment, the payment processing module 139 processes the user 101 online transaction. In an example embodiment, the user 101 accesses the merchant website 131, selects a product for purchase, and transmits financial account information, which the merchant website 131 then transmits to the payment processing module 139.

An example account management system 140 comprises an account management module 141, a website logging module 143, and a conversion analyzer module 145. In an example embodiment, the account management system 140 communicates with the user device 110 via the account management module 141. In an example embodiment, user device 110 has an application 115 distributed by the account management system 140 that enables the user 101 to access his account. In another example embodiment, the user 101 accesses his account via the web browser 117 of the user device 110. In an example embodiment, when the user 101 accesses his account via the application 115 or web browser 117, the account management module 141 logs user device 110 location data.

In an example embodiment, the website logging module 143, in response to a user 101 selecting a location-based offer provided by the account management system 140 via the web browser 117, transmits a cookie to the user device web browser 117. In this same example embodiment, when the user 101 transacts with the merchant system 130 website 131, the account management system 140 notifies the conversion analyzer module 145 to log the online conversion.

In an example embodiment, the conversion analyzer module 145 logs online conversions. For example, an online conversion occurs when the account management system 140 logs a user device 110 location and transmits a location-based offer to the user device 110, leading later to an online user 101 activity. In an example embodiment, the conversion analyzer module 145 is notified by the website logging module 143 that the user 101 has made an online purchase with a web browser 117 that had received a cookie as a result of the user 101 receiving a location-based offer from the account management system 140. In this same example embodiment, the conversion analyzer module 145 logs the online conversion. In another example embodiment, the conversion analyzer module 145 is notified that the user 101 initiated an online purchase using a payment application (for example, a digital wallet application) or payment instrument associated with the account management system 140. In this same example embodiment, the conversion analyzer module 145 determines whether the user 101 received a location-based offer in association with the user device 110 being logged at a particular location.

It will be appreciated that the network connections shown are example and other means of establishing a communications link between the computers and devices can be used. Moreover, those having ordinary skill in the art having the benefit of the present disclosure will appreciate that the user computing device 110, the merchant system 130, and the account management system 140 illustrated in FIG. 1 can have any of several other suitable computer system configurations. For example, a user computing device 110 embodied as a mobile phone or handheld computer may or may not include all the components described above.

### Example Processes

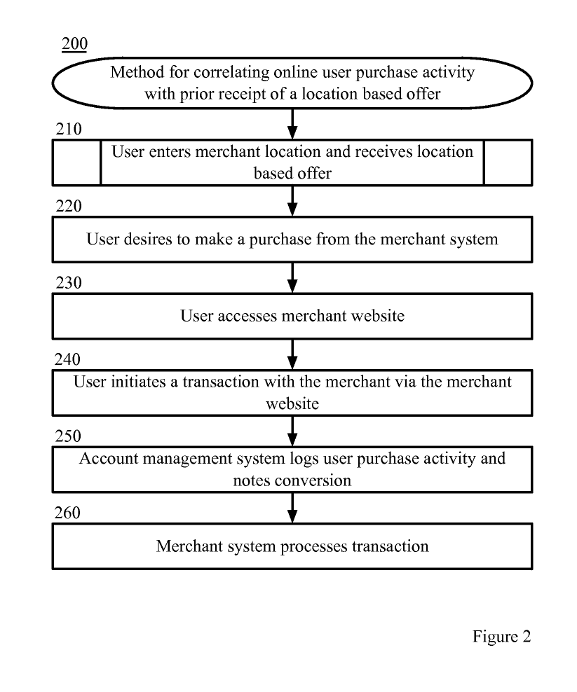

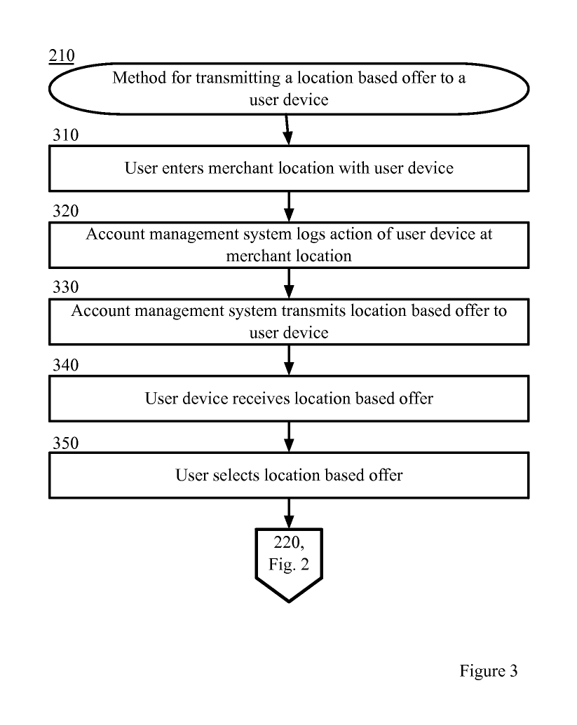

The example methods illustrated in FIGS. 2-3 are described hereinafter with respect to the components of the example operating environment 100. The example methods of FIGS. 2-3 may also be performed with other systems and in other environments.

FIG. 2 is a block diagram depicting a method 200 for correlating online user purchase activity with prior receipt of a location-based offer, in accordance with certain example embodiments. The method 200 is described with reference to the components illustrated in FIG. 1.

In block 210, the user 101 enters a merchant location and receives a location-based offer. In an example embodiment, a location-based offer is an advertisement or a coupon that is transmitted when the user device is in a certain physical location. In certain embodiments, the user 101 does not receive a location-based offer, but the location of the user computing device 110 is still logged. For example, the user 101 enters the merchant location and the location of the user computing device 110 is logged by the account management system 140. In another example, the user 101 may execute an action via the user computing device 110 to enable the account management system 140 to receive user computing device 110 location data such as provide a check-in on a social network site or sign in to a user 101 account associated with the account management system 140 and the account management system 140 may still consider a purchase as a conversion of the user 101 experience to a purchase.

FIG. 3 is a block diagram depicting a method 210 for transmitting a location-based offer to a user device 110, in accordance with certain example embodiments. The method 210 is described with reference to the components illustrated in FIG. 1.

In block 310, the user 101 enters a location of the merchant system 130 with the user device 110. In an example embodiment, the user 101 brings a user computing device 110 to the merchant system 130 physical location and receives the location-based offer via the user computing device 110. For example, the user 101 enters a merchant store, supermarket, or warehouse and receives a location-based offer on his mobile phone. In an example embodiment, the user computing device 110 is a mobile phone or other mobile user device 110 that can connect to a network 120.

In block 320, the account management system 140 logs an action of the user device 110 at the merchant location. In an example embodiment, the user 101 has authorized a location-based alert application 115. For example, the location-based alert application 115 may be an application 115 that the user 101 configures to notify or remind the user 101 of certain items or to complete certain tasks when the user 101 enters a certain location. In another example, the location-based alert application 115 provides useful information (such as, weather alerts, notifications of nearby criminal activity, traffic alerts) based on the user's 101 current location. In another example embodiment, the user 101 signs in to a merchant's Wi-Fi network 120. For example, the user computing device 110 finds the merchant network 120 by exchanging probing requests with a merchant network device 137 and the user 101 selects the merchant Wi-Fi network 120 via a user interface 111 object on the web browser 117 to sign in. The user computing device 110 obtains location information from the merchant network device 137. In another example embodiment, the user 101 purchases a product at the merchant location using the user device 110 digital wallet that is associated with the account management system 140. In yet another example embodiment, the user 101 signs in to the application 115 via the user computing device 110 and agrees to submit a current location to the account management system 140. For example, the user 101 signs in to a mapping application 115 administered by the account management system 140 to get directions to the merchant location. In this same example, the user 101 agrees to submit location data for the account management system 140 to provide the mapping service. In this same example, the account management system 140 logs the user's 101 location when he arrives at the merchant location. In certain embodiments, the user 101 has provided instructions for the user computing device 110 to notify the account management system 140 when the user computing device 110 is within a configured distance from the location of the merchant system 140.

In block 330, the account management system 140 transmits a location-based offer to the user device 110. In an example embodiment, a location-based offer is an advertisement or a coupon that is transmitted when the user device's 110 location is logged at a certain physical location. In an example embodiment, the account management system 140 transmits a location-based offer on behalf of the merchant system 130 associated with the merchant location. For example, the account management system 140 agrees to provide location-based offers for the merchant system 130 to users having an account with the account management system 140. In another example embodiment, the account management system 140 transmits a location-based offer on behalf of another merchant (or manufacturer) for whom the merchant system 130 sells a product or service at the merchant location. For example, Merchant A (or Manufacturer A) produces a product or service which Merchant B provides or sells at Merchant B's physical location. In this same example, the account management system 140 transmits a location-based alert on behalf of Merchant A (or Manufacturer A) to the user 101 when the user 101 enters Merchant B's location.

In block 340, the user device 110 receives the location-based offer. In an example embodiment, the user 101 receives the location-based offer on the user computing device 110 via email, text message, an application 115 resident on the user computing device 110, the merchant website 131 or other website active on the user computing device 110 web browser 117, or by any other method wherein the user 101 may receive the location-based offer on the user computing device 110.

In block 350, the user 101 selects the location-based offer. In an example embodiment, the user actuates a user interface 111 object to select the offer. For example, the user 101 touches a touchscreen interface 111 of the user computing device 110 to select the location-based offer. In another example embodiment, the user 101 does not select the location-based offer. For example, rather than the user 101 selecting the location-based offer, the location-based offer captures the user's 101 attention. For example, the location-based offer is designed to expand to occupy the user interface 111 of the user device 110, play a sound recording, or cause the user device 110 to vibrate.

Returning to FIG. 2, in block 220, the user 101 desires to make a purchase from the merchant system 130. In an example embodiment, the user 101 left the merchant's physical location before making the purchase. For example, the user 101 returns home or to another location and desires to purchase a product or service online. For example, a “product” may be any tangible or intangible product, as well as a service. In another example embodiment, the user 101 is at the merchant's location but desires to purchase the product advertised online. In another example embodiment, the user 101 desires to make a purchase from a manufacturer or merchant other than the merchant system 130. For example, the location-based offer advertised a product or service that Merchant A supplies at the merchant location, but the user 101 desires to purchase the product or service directly from the manufacturer or service provider or from Merchant B, which supplies the product or service to the Merchant A.

In block 230, the user 101 accesses the merchant website 131. In an example embodiment, the user 101 accesses the merchant website 131 with the same user computing device 110 from which the account management system 140 logged location data. For example, the user 101 enters the merchant location with a mobile phone device 110 and later accesses the website 131 with the same mobile phone device 110. In another example embodiment, the user 101 accesses the merchant website using another user computing device 110. For example, the user 101 entered the merchant location with the mobile phone device 110, but accesses the merchant website 131 with a second mobile phone device 110 or a desktop computer device 110.

In block 240, the user 101 initiates a transaction with the merchant via the merchant website 131. In an example embodiment, the user 101 selects a product or service to purchase and selects a form of payment administered by the account management system 140. For example, the user 101 selects a proxy account administered by the account management system 140 or digital wallet account associated with the account management system 140 comprising financial account information as the form of payment. In another example embodiment, the user 101 uses the location-based offer comprising a coupon in the transaction. For example, the user 101 enters the merchant location and receives a discount coupon code for an online purchase, which the user 101 redeems in the online transaction.

In block 250, the account management system 140 logs the user 101 purchase activity and notes a conversion. In an example embodiment, a conversion occurs when a user 101 receives a location-based offer and then later purchases online a product or service from a merchant or manufacturer associated with the offer. In another example embodiment, a location-based offer is not received after the account management system 140 logs the user device 110 location data at a merchant location and the conversion occurs when the user computing device 110 location is logged at the merchant location and then the user makes an online purchase of a product or service from a merchant or manufacturer associated with the merchant location. In this same example embodiment, the user 101 may be exposed to an in-store advertisement or coupon by the merchant system 130 in association with the account management system 140 logging the location data. For example, the user 101 enters the merchant's physical location and listens to a sales demonstration, receives a coupon, or receives an offer or other advertisement or offer, before or after performing an action on the user device 110 that enables the account management system 140 to log the location data. In this same example, the user 101 later desires to make a purchase and initiates a transaction on the merchant website 131, which the account management system correlates with the user computing device 110 location data log.

In an example embodiment, the account management system 140 is notified of the user's 101 purchase activity because the method of payment selected by the user 101 is managed by the account management system 140. For example, the user 101 pays with a digital wallet or proxy card associated with the account management system 140. In another example embodiment, the account management system 140 places a cookie on the user computing device 110 when the user 101 selects the location-based offer on the user computing device 110. In this same example embodiment, the account management system 140 recognizes the cookie on the user computing device 110 web browser 117 when the user 101 initiates the online transaction. In another example, the account management system 140 is notified of the purchase activity by the merchant system 130 or the website 131 on which the user conducted the transaction. In an example embodiment, the account management system 140 receives information about the user 101 purchase activity concerning the identity of the merchant system 130 with which the user 101 transacted and/or concerning a product or service purchased by the user 101. The account management system 140 stores the information. For example, the account management system 140 is notified by the merchant system 130 or a cookie on the user computing device web browser 117. The account management system 140 may determine that the user 101 purchased a certain product from the merchant system 130 in any other suitable manner.

In an example embodiment, the account management system 140 compares the user's 101 purchase activity information with the location information to note a conversion. In an example embodiment, the account management system 140 saves location data logged by and received from the user computing device 110. In an example embodiment, the account management system 140 keeps a record of location-based offers sent to the user computing device 110. In an example embodiment, the account management system 140 searches saved user computing device 110 location data and/or the record of location-based offers sent to the user computing device 110 to identify information corresponding to the user's 101 purchase activity information to note a conversion. For example, the account management system 140 identifies in the user's 101 purchase activity information that the user 101 purchased product A from merchant B in an online transaction and identifies that location data was received from the user computing device 110 that shows that the user computing device 110 was previously located at merchant B's physical location. In this example, the account management system 140 notes a conversion. In this example, the account management system 140 may need to identify a location-based offer sent by the account management system 140 to the user computing device 110 associated with logged user computing device 110 location data to note the conversion.

In block 260, the merchant system 130 processes the transaction. For example, the merchant system 130 credits the merchant's financial account and debits the user's 101 financial account. In another example embodiment, a manufacturer or other merchant associated with the purchase website processes the transaction.

The account management system 140 logs the conversion. The conversion may be logged by the account management system 140 to use for statistical purposes, to serve future offers, or for any suitable purpose. The conversion may be transmitted to the merchant system 130, a manufacturer, or other party by the account management system 140. The conversion may be billed to a merchant system 140, a manufacturer, or other party. The account management system may use the conversion for any suitable purpose.

### Other Example Embodiments

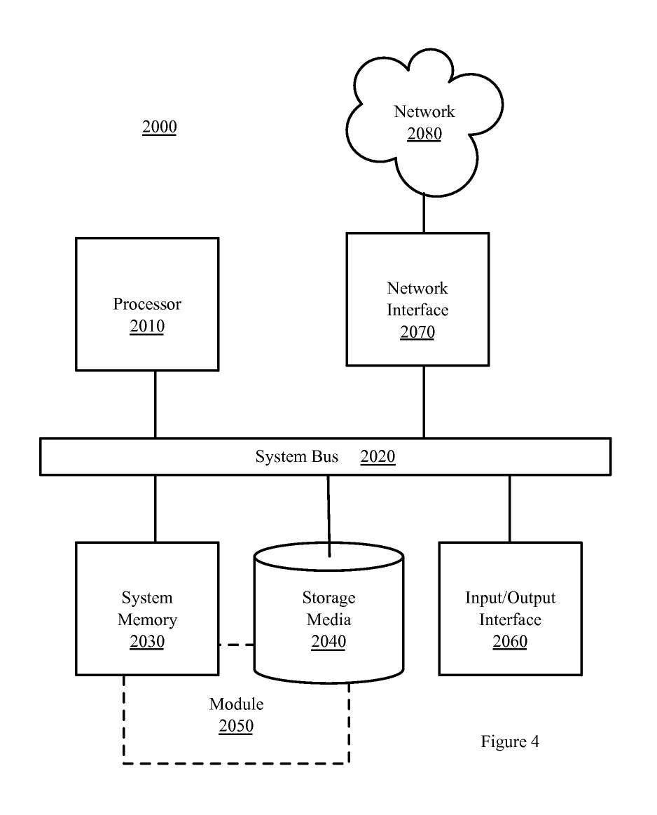

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, a television with one or more processors embedded therein and/or coupled thereto, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to link previous physical location information with subsequent online computing activity to determine a conversion of information received at the previous physical location via the subsequent online computing activity, comprising:
transmitting, by one or more computing devices and to a user computing device, a request for a location of the user computing device;
receiving, by the one or more computing devices, a response from the user computing device comprising data indicating the location of the user computing device;
after receiving the location data of the user computing device, logging an identifier associated with a location-based offer;
transmitting, by the one or more computing devices, the location-based offer to the user computing device, wherein the location-based offer corresponds to the logged location of the user computing device, wherein, at a time after the location-based offer is transmitted to the user computing device, the user interacts with the location-based offer via the user computing device and wherein the user computing device logs the identifier associated with the location based offer;
receiving, by the one or more computing devices at a time after an online purchase transaction between the user and a merchant computing system is competed, online purchase transaction data comprising the identifier associated with the location based offer, wherein the user computing device transmits the transaction data comprising the identifier to the one or more computing devices;
identifying, by the one or more computing devices, from the online purchase transaction data, the merchant computing system associated with the online purchase transaction;
identifying, by the one or more computing devices, an online conversion in response to determining:
that the previously logged location of the user computing device corresponds to a physical location associated with the identified merchant computing system; and
that the location-based offer corresponding to the previously logged user computing device location was used in the online purchase transaction; and
transmitting, by the one or more computing devices and in response to identifying the online conversion, notification of the online conversion of the transmitted location-based offer.

2. (canceled)

3. The method of claim 1, wherein the location-based offer comprises an advertisement or coupon.

4. The method of claim 1, wherein the location of the user computing device is logged at the physical location associated with the merchant computing system.

5. (canceled)

6. The method of claim 1, wherein, at a time after the location-based offer is transmitted to the user computing device, the user interacts with the location-based offer via the user computing device.

7. (canceled)

8. The method of claim 1, wherein the location of the user computing device is logged in response to the user logging in, via the user computing device, to an application that communicates with the one or more computing devices.

9. The method of claim 6, wherein the location-based offer comprises a cookie, wherein the cookie is downloaded onto the user computing device when the user interacts with the location-based offer via the user computing device, and wherein the online user purchase activity is logged using the cookie.

10. The method of claim 1, wherein the location of the user computing device is logged in response to the user establishing a connection between the user computing device and a Wi-Fi network at the merchant location.

11. The method of claim 1, wherein the location of the user computing device is logged in response to the user checking in on a social network website or social network application.

12. A non-transitory computer-readable storage medium having computer-readable program instructions embodied thereon that when executed by a computer cause the computer to link previous physical location information with subsequent online computing activity to determine a conversion of information received at the previous physical location via the subsequent online computing activity, the computer-readable program instructions comprising:
computer-readable program instructions to log a location of a user computing device that is associated with a user;
computer-readable program instructions to transmit, after logging the logged location of the user computing device a location-based offer to the user computing device, wherein the location-based offer corresponds to the logged location of the user computing device, wherein, at a time after the location-based offer is transmitted to the user computing device, the user interacts with the location-based offer via the user computing device;
computer-readable program instructions to log data associated with an online purchase transaction between the user and a merchant computing system;
computer-readable program instructions to receive transaction information corresponding to the logged online purchase transaction;
computer-readable program instructions to identify, from the received transaction information, the merchant computing system or a particular product associated with the online purchase transaction;
computer-readable program instructions to determine that the previously logged location of the user computing device corresponds to the particular product or corresponds to a physical location associated with the identified merchant computing system;
computer-readable program instructions to identify an online conversion of the location-based offer based on the correspondence between the logged location of the user computing device and the physical location associated with the identified merchant computing system or based on the correspondence between the logged location of the user computing device and the particular product; and
computer-readable program instructions to transmit, in response to identifying the online conversion, notification of the online conversion to the merchant computing system.

13. The non-transitory computer readable storage medium of claim 12, further comprising computer-readable program instructions to transmit a location-based offer to the user computing device, wherein the location-based offer corresponds to the location of the user computing device.

14. The non-transitory computer readable storage medium of claim 12, wherein the location of the user computing device is logged at a physical location associated with the merchant system.

15. The non-transitory computer readable storage medium of claim 12, wherein the location of the user computing device is logged in response to receiving an indication of an action initiated by the user with respect to the user computing device.

16. The non-transitory computer readable storage medium of claim 13, wherein the user interacts with the location-based offer on the user computing device at a time after the location-based offer is transmitted to the user computing device.

17. The non-transitory computer readable storage medium of claim 12, wherein the online conversion is identified when the online user purchase activity occurs at an online merchant system separate from the merchant computing system.

18. A system to link previous physical location information with subsequent online computing activity to determine a conversion of information received at the previous physical location via the subsequent online computing activity, comprising:
a storage device; and
a processor communicatively coupled to the storage device, wherein the processor executes application code instructions that are stored in the storage device to cause the system to:
log a location of a user computing device that is associated with a user;
transmit, after logging the logged location of the user computing device a location-based offer to the user computing device, wherein the location-based offer corresponds to the logged location of the user computing device, wherein, at a time after the location-based offer is transmitted to the user computing device, the user interacts with the location-based offer via the user computing device;
log data associated with an online user purchase transaction between the user and a merchant computing system;
receive transaction information corresponding to the logged online purchase transaction;
identify, from the received transaction information, the merchant computing system or a particular product associated with the online purchase transaction;
determine that the previously logged location of the user computing device corresponds to the particular product or corresponds to a physical location associated with the identified merchant computing system;
identify an online conversion of the location-based offer based on the correspondence between the logged location of the user computing device and the physical location associated with the identified merchant computing system or based on the correspondence between the logged location of the user computing device and the particular product; and
transmit, in response to identifying the online conversion, notification of the online conversion to the merchant computing system.

19. The system of claim 18, wherein the processor is further configured to execute computer-readable program instructions stored in the storage medium to cause the system to transmit a location-based offer to the user computing device, wherein the location-based offer corresponds to the location of the user computing device and corresponds to the particular product.

20. The system of claim 18, wherein determining that the previously logged location of the user computing device is associated with the particular product or is associated with the physical location associated with the identified merchant computing system comprises determining that a merchant system performed a live demonstration of the particular product at the logged location at a time the location was logged.
